(19) United States
(12) Patent Application Publication
(10) Pub. No.: US 2002/0051269 A1
(43) Pub. Date: May 2, 2002

(54) Reconfigurable over-the-air optical data transmission system

(76) Inventors: Shlomo Margalit, Winnetka, CA (US); Herzel Laor, Boulder, CO (US)

Correspondence Address: NEIL K. NYDEGGER, NYDEGGER & ASSOCIATES, 348 Olive Street, San Diego, CA, 92103, US

(21) Appl. No.: 09/967,911

(22) Filed: Sep. 28, 2001

Related U.S. Application Data
(60) Provisional application No. 60/236,540, filed on Sep. 29, 2000.

(51) Int. Cl. H04B 10/20; H04J 14/00; H04B 10/00

(52) U.S. Cl. 359/172; 359/118

(57) ABSTRACT

An over-the-air optical data communications system includes a plurality of transmission units that are mounted at separate locations in a geographical area to establish a mesh network that includes a plurality of line-of-sight optical communications links. A network controller is electronically connected with each communications link to monitor transmission quality on the link, and to selectively aim each transmission unit in the mesh network to an alternate transmission unit as required to maintain the mesh network. Additionally, a backbone network holds the mesh network together by interconnecting various communications stations that are each connected with at least one transmission unit in each of the communications links.

This application claims priority of Provisional Application Serial No. 60/236,540, filed Sep. 29, 2000.

### FIELD OF THE INVENTION

The present invention pertains generally to systems and methods for implementing optical communications networks. More particularly, the present invention pertains to optical communications systems which incorporate controls for converting the system whenever an optical communication link in the system becomes unusable. The present invention is particularly, but not exclusively, useful as a two-tiered system which includes a secondary communications system that provides an underpinning for supplementary control and selective conversion of the optical communications links in the optical communications links of a primary system.

### BACKGROUND OF THE INVENTION

Optical systems for establishing line-of-sight communications links between two end-point communications terminals have been successfully employed in several configurations. More particularly, such optical links have become more commonly used in urban environments over the so-called “last mile” of a communications network. An example of such an optical link is disclosed and claimed in U.S. Pat. No. 5,777,768, which issued to Korevaar on Jul 7, 1998, for an invention entitled “Multiple Transmitter Laser Link” and which is assigned to the assignee of the present invention.

In addition to their use as a point-to-point communications link, optical systems have also been employed in various network schemes. Additionally, they have been used in conjunction with other types of communications equipment. For example, U.S. Pat. No. 6,049,593, which issued to Acampora on Apr. 11, 2000, for an invention entitled “Hybrid Universal Broadband Telecommunications Using Small Radio Cells interconnected by Free-Space Optical Links,” discloses a multi-tier communications system that incorporates both radio and optical telecommunications equipment.

It is well known that whenever a wireless optical telecommunications link is used in a communications system, it is vulnerable to difficulties that are associated with the variable attenuation of the media (air, free space). More specifically, randomly occurring phenomena such as fog, smoke, and precipitation can attenuate an optical link to the point where it is effectively inoperative. This factor is somewhat aggravated by the fact that, unless turning mirrors are used, optical systems which transmit light beams through free space are effectively limited to a line-of-sight link. Heretofore, the solution for overcoming an unwanted obstruction that has been introduced into an optical communications system has been to reroute communications from the affected link onto other preexisting links. The effectiveness and flexibility of this tactic, however, depends on the existence of preexisting links.

In light of the above, it is an object of the present invention to provide a reconfigurable, over-the-air optical data communications system which incorporates optical transmission units that can be selectively aimed to establish alternate optical links, and to thereby convert a mesh network of optical links into an alternate mesh network which includes the alternate optical link(s). Another object of the present invention is to provide a reconfigurable over-the-air optical data communications system that incorporates a backbone network of landlines, or wireless or optical connections which will supplement a mesh network of optical communications links. Yet another object of the present invention is to provide a reconfigurable, over-the-air optical data communications system that coordinates the location of optical transmission units, together with the direction of respective optical beam paths from these transmission units in both elevation and azimuth, to selectively establish optical communications links in a mesh network. Still another object of the present invention is to provide a reconfigurable, over-the-air optical data communications system that is relatively easy to install, is simple to use, and is comparatively cost effective.

### SUMMARY OF THE PREFERRED EMBODIMENTS

An over-the-air optical data communications system in accordance with the present invention includes a plurality of transmission units that are mounted at separate locations throughout a regional area (e.g. an urban environment). More specifically, a number of such transmission units will be located at each of several separate transmission terminals. For example, in an urban environment the transmission terminals may be buildings or towers. Further, for the present invention there will be at least one, but probably two or more, transmission unit(s) at each transmission terminal. As envisioned for the present invention, a transmission unit at one terminal and a transmission unit at another terminal will be aimed toward each other to establish a line-of-sight optical data communications link therebetween. Several such line-of-sight optical communications links will thus establish a mesh network of communications links.

The system of the present invention also includes a backbone network which provides an underpinning for control and conversion of the mesh network. More specifically, this backbone network includes a plurality of separate communications stations which are positioned at selected transmission terminals in the mesh network. Also, each of these communications stations is interconnected with at least two other communications stations and, preferably, they are all interconnected into a closed loop. Importantly, in addition to the transmission units that are used for the mesh network, each communications station in the backbone network may have an excess of pre-positioned transmission units that can be employed, as necessary, to replace outages of communications links in the mesh network. For purposes of the present invention, the communications links between communications stations in the backbone network can be either landline, wireless, or optical connections.

Operation of the mesh network, as well as its interaction with the backbone network of the present invention, is accomplished by a network controller. As the operational nerve-center for the optical communications system of the present invention, this network controller is electronically connected with each of the communications links in the mesh network. Through these connections, the network controller performs several important functions. For one, it monitors the transmission quality on each of the communications links. Then, in response to the level of a predetermined transmission quality factor, the network controller provides commands for aiming appropriate transmission units toward each other. This action then converts the mesh network into an alternate mesh network in the event the transmission quality factor indicates a particular communications link, or links, has (have) become operationally ineffective.

For its operation, the network controller is provided with information concerning the exact location of each transmission unit in the mesh network. Specifically, this information will include the coordinates and the height of each transmission unit relative to a predetermined datum. Using this information, the network controller is then capable of selectively aiming each transmission unit, in both elevation and azimuth, from its known location toward another transmission unit in the mesh network. Also, based on experience or actual measurements, line-of-sight blockages (e.g. mountains, buildings, walls and towers), can be preprogrammed into the network controller to more accurately define the operational envelope for each transmission unit. Accordingly, initial line-of-sight optical communications links can be established for the mesh network. Subsequently, this same information can be used to establish alternate line-of-sight optical communications links for an alternate mesh network in the event an unforeseen blockage is experienced (e.g. fog, smoke, or precipitation) of optical communications links.

As a back-up for the network controller, local controllers can be installed at selected transmission terminals. Similar to the network controller, these local controllers will be provided with information concerning the exact location of transmission units at their respective transmission terminal, as well as information about transmission units at other terminals with which they can establish optical line-of-sight communications links. As before, this information will include the coordinates and the height of each transmission unit relative to the predetermined datum. In normal operation, the local controller will be used to interconnect the mesh network with the network controller. Alternatively, in the event there is an outage of the network controller, the local controller can be used to aim transmission units under its control to maintain or reconfigure the mesh network.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an urban environment which incorporates a reconfigurable over-the-air optical data communications system in accordance with the present invention;

FIG. 2 is a schematic view of a mesh network in the optical communications system of the present invention, as shown in FIG. 1, superposed on a backbone network of the system for concerted operation therewith;

FIG. 3 is a schematic view of a communications terminal in the optical communications system of the present invention; and

FIG. 4 is a flow chart of actions and decisions that are to be taken to set-up or reconfigure the optical data communications system in accordance with the present invention.

### DESCRIPTION OF THE PREFERRED EMBODIMENT

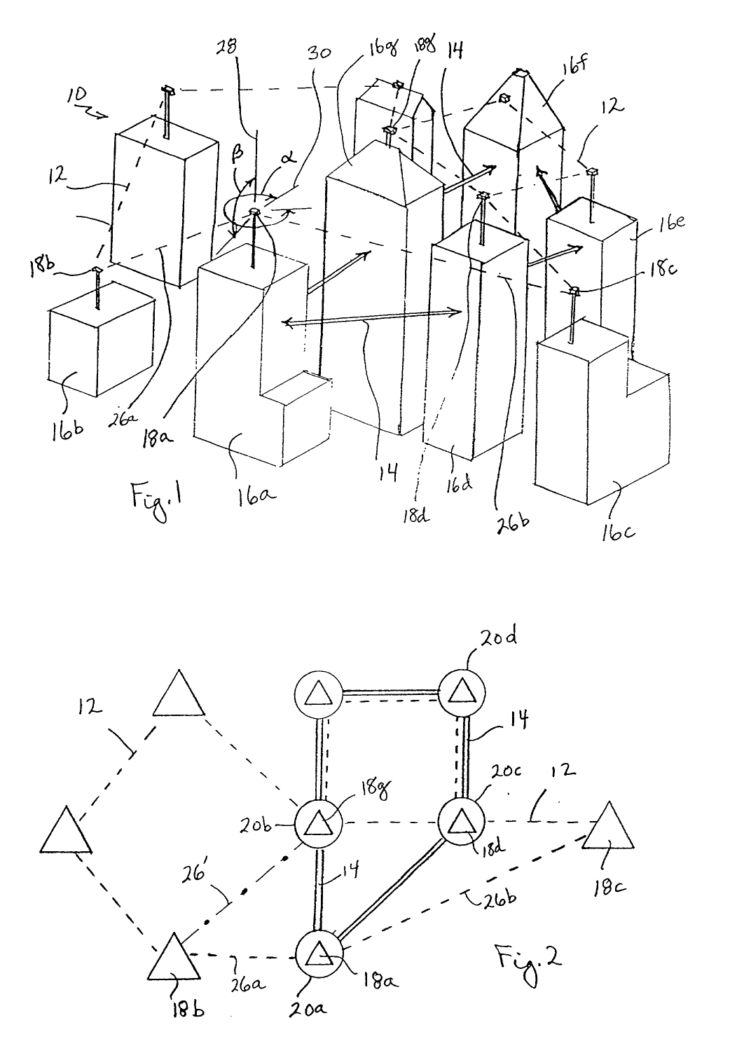

Referring initially to FIG. 1 a reconfigurable optical communications system in accordance with the present invention is shown and generally designated 10. As shown, the system 10 includes a mesh network 12 (dashed lines) and a backbone network 14 (double lines). As also shown in FIG. 1, both the mesh network 12 and the backbone network 14 interconnect various transmission terminals 16 (e.g. buildings) which are located in a same regional area (e.g. urban environment).

To consider the interaction of the mesh network 12 with the backbone network 14, in detail, it will be seen that the mesh network 12 includes a plurality of interconnected transmission modules 18. More specifically, these transmission modules 18 are mounted on respective buildings 16 that are to be connected into the mesh network 12. For example, the module 18a is shown mounted or positioned on the building 16a and, likewise, the modules 18b and 18c are shown positioned on respective buildings 16b and 16c. As also shown, additional modules 18 are similarly mounted on other respective buildings 16. On the other hand, the backbone network 14 is mounted on selected buildings 16 in the regional area covered by the system 10 of the present invention. More specifically, the backbone network 14 includes a plurality of communication stations 20, of which the communications stations 20a-d shown in FIG. 2 are only exemplary.

As best seen in FIG. 2, where the schematics of mesh network 12 and backbone network 14 are superposed on each other, it is possible for a transmission module 18 and a communications station 20 to be co-located at the same building 16. For instance, by cross referencing FIG. 1 and FIG. 2 it will be appreciated that the transmission module 18a and the communications station 20a are co-located at the transmission terminal (building) 16a. As intended for the present invention, the communications stations 20 of the backbone network 14 can be interconnected with each other in any of several ways known in the pertinent art, such as by landlines, wireless or optical communications links. Preferably, the backbone network 14 is configured as a closed loop wherein each transmission terminal (building) 16 in the loop is connected with at least two other communications stations 20 (e.g. buildings 16a-16d-16e-16f-16g). Unlike the backbone network 14, however, the mesh network 12 for system 10 is specifically dedicated to optical communications links.

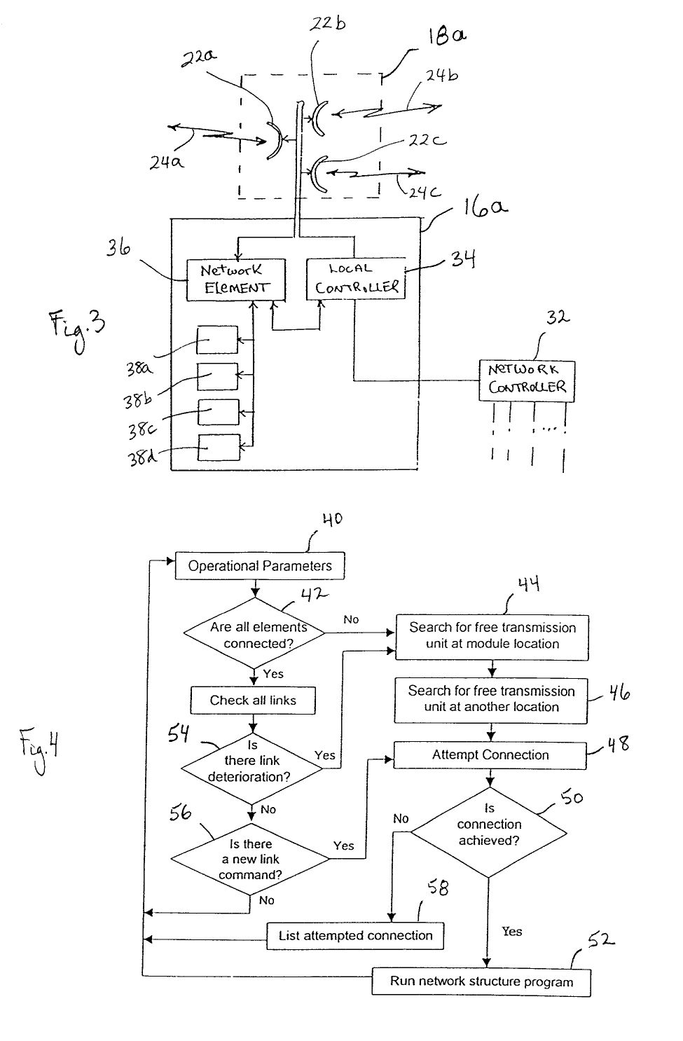

Referring now to FIG. 3 it will be seen that the present invention contemplates the use of a plurality of transmission units 22 in each transmission module 18. For example, the transmission module 18a is shown in FIG. 3 to include the transmission units 22a, 22b, and 22c. Although the transmission module 18a shown in FIG. 3 is indicated to be on the top of the transmission terminal 16a (i.e. roof of the building 16a), it is to be appreciated that the transmission units 22a-c, or additional transmission units 22, can be positioned on the side of the terminal 16a or at any convenient location which will ensure the establishment of a line-of-sight optical communications link 26. Regardless where they are located, each transmission unit 22a-c is capable of generating a respective light beam 24a-c which is useful for optical communications. For this purpose it is necessary to consider the alignment of transmission units 22 at respective transmission terminals 16.

In FIG. 1, and with reference to FIG. 3, the transmission module 18a is used as an exemplary consideration. More specifically, consider the transmission unit 22a. As intended for the present invention, the transmission unit 22a must be capable of being aimed to establish an optical communications link 26. For example, as shown in FIG. 1, the transmission unit 22a in module 18a at building 16a must be aimed to establish the optical communications link 26a with a transmission unit 22 in the module 18b on building 16b. This aiming, of course, requires that the transmission unit 22a be capable of traversing angles in both elevation and azimuth.

Still referring to FIG. 1, an elevation angle, β, can be measured from a vertical axis 28 at the transmission module 18a, and an azimuth angle, α, can likewise be measured from a horizontal axis 30. The range of the respective angles α and β will depend on obstructions. In the case shown in FIG. 1 the elevation angle, β, is restricted by the building 16a while the azimuth angle, α, is primarily restricted by the building 16g. In any event, by knowing the coordinates of the transmission unit 22a (e.g. longitude and latitude), and its elevation (e.g. above mean sea level), the aiming angles α and β can be appropriately selected to establish an end point for the optical communications link 26a. Similar measurements for a transmission unit 22 in the module 18b on building 16b, with reciprocal aiming angles for α and β, will then complete the optical communications link 26a. With the above in mind, it is an important aspect of the present invention that the system 10 have accurate information as to the coordinates (e.g. longitude and latitude) and elevation (e.g. above mean sea level) of each individual transmission unit 22 in the mesh network 12. Alternately, the relative aiming angles α and β for all possible links 26 in the system 10 can be known. With such information, the establishment of various optical communications links 26 between any two transmission units 22 in the mesh network 12 is simply a matter of orienting the different transmission units 26 with appropriate aiming angles α and β.

FIG. 3 indicates that overall control of the system 10 is provided by a network controller 32 which can be selectively located anywhere in the regional area that is being serviced by the system 10. Further, FIG. 3 indicates that a local controller 34 may be located at a transmission terminal (e.g. building 16a) as desired. The purpose of the local controller 34 is to serve as a back-up for the network controller 32 in the event the latter becomes inoperative for some reason. In either case, the network controller 32 will have the position information disclosed above for all transmission units 22 in the mesh network 12. On the other hand, local controllers 34, if used, need have position information on only those transmission units 22 with which the transmission module 18 at its particular terminal (building) 16 can communicate.

Using the transmission terminal (building) 16a as an example (see FIG. 3), it will be seen that a network element 36 is connected directly with the transmission units 22a-c. With these connections, wireless optical communications can be conducted on the respective light beams 24a-c and, consequently, over respective optical communications links 26. Various communications devices 38 (the devices 38a-d are only exemplary) can then be connected onto the mesh network 12 through the network element 36.

In the operation of the system 10 of the present invention, the transmission units 22 in various modules 18 are initially aimed to establish communications links 26 for the mesh network 12. Also, the backbone network 14 is established. Again, the particular mesh network 12 and backbone network 14 shown in FIGS. 1 and 2 are only exemplary. The importance of the system 10 is to then reconfigure the mesh network 12 in the event there is a system outage.

Returning for the moment to FIG. 2, consider the possibility that fog, smoke, rain or some other attenuating phenomenon obscures optical communications with the transmission module 18a on building 16a. If this happens, the wireless optical communications link 26a (between terminals 18a and 18b) and the link 26b (between terminals 18a and 18c) may become ineffective. Under such a scenario, the network controller 32 performs a logic routine that is intended to reconfigure the mesh network 12 into a viable alternate mesh network 12′ that will restore effective communications. Such a logic routine is shown in FIG. 4.

In FIG. 4, block 40 indicates that the network controller 32 (possibly local controller 34, if used) maintains the operational parameters for the system 10. As implied above, these operational parameters will include the position information on transmission units 22 in the system 10. Additionally, these operational parameters can include pertinent system reports and graphic user interface information for the operator of the network controller 32. In an on-going operation, as indicated by inquiry block 42 in FIG. 4, the network controller 32 monitors the network elements 36 and, thus, the transmission units 22 that are initially connected into the mesh network 12. If, as in the scenario presented above, the transmission terminal 16a becomes somehow disconnected, inquiry block 42 directs action to block 44 and a search for free transmission units 22. Simultaneously, as indicated by block 46, a search is made for free transmission units 22 at other locations (i.e. terminals 18). An attempt is then made to establish the affected communications link 26 (see block 48), and if successful (block 50) the mesh network 12 is reestablished (block 52).

It may happen that a particular communications link 26 in the mesh network 12 may not be completely inoperative, but it begins to deteriorate. As indicated by the inquiry block 54, if this happens an attempt is made as disclosed above (blocks 44, 46, 48, 50 and 52) to reestablish the link 26. On the other hand, it can happen that the link has gone beyond deterioration, at this point inquiry block 56 questions whether there is a command for a new link. In this context, consider the scenario presented above.

For situations, such as where optical communications have been disrupted with a transmission terminal 16 (e.g. terminal 16a) a new link command can be given. In this case, it can happen that the communications link 26a shown in FIG. 2 becomes unusable. The network controller 32 may then command a transmission unit 22 of the module 18b at transmission terminal 16b to establish an alternate optical communications link 26′ with the transmission module 18g at transmission terminal 16g (indicated by the dot-dash line in FIG. 2). Alternatively, the network controller 32 may have commanded the transmission unit 22 of the module 18b to establish an optical communications link 26 with the transmission module 18d at transmission terminal 16d, if possible. The consequence in either case is an alternate mesh network 12′ that can be used until such time as the initial mesh network 12 can be reconstituted.

In all of the possible situations discussed above, the block 58 in FIG. 4 indicates that the network controller 32 will make reports on outages for future use in reconfigurations of the mesh network 12. Importantly, as envisioned for the present invention, the mesh network 12 can be reconfigured to maintain or restore communications by reconfiguring the network 12 with new optical communications links 26. As disclosed above, this is accomplished by creating new optical communications links 26, as required. More specifically, these new communications links are established when selected transmission units 22, at selected transmission terminals 16 are caused to be aimed at each other to create the particular link 26.

While the particular Reconfigurable Over-the-Air Optical Data Transmission System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A reconfigurable over-the-air optical data communications system which comprises:
a plurality of transmission units mounted at a respective plurality of separate locations to establish a mesh network having a plurality of line-of-sight optical communications links, wherein each said communication link interconnects one said transmission unit with another said transmission unit for communicating data therebetween;
and
a network controller electronically connected with each said communications link of said mesh network for monitoring a transmission quality factor for each said communications link, and for converting said mesh network by aiming at least one said transmission unit of a selected communications link to an alternate transmission unit to establish an alternate communication link in said mesh network in lieu of said selected communication link when said transmission quality factor of said selected communication link passes through a predetermined value.

2. A system as recited in claim 1 further comprising a backbone network which comprises:
a plurality of separate communications stations;
means for connecting each said communications station with at least one other said communications station; and
means for connecting at least one said transmission unit of each said communications link in data communications with at least one said communication station.

3. A system as recited in claim 2 wherein said means for connecting each said communications station with at least one other said communications station is a land line.

4. A system as recited in claim 2 wherein said means for connecting each said communications station with at least one other said communications station is an optical line-of-sight communications link.

5. A system as recited in claim 2 wherein each said communications station is connected with two other communications stations to form a closed communications loop for said backbone network.

6. A system as recited in claim 1 wherein said transmission unit includes means for selectively aiming a light beam from said location in elevation and azimuth.

7. A system as recited in claim 6 wherein said network controller comprises:
means for determining said location of each said transmission unit in said mesh network; and
means connected with said aiming means of each said transmission unit for controlling elevation and azimuth of each said transmission unit to establish said line-of-sight optical communications links of said mesh network.

8. A system as recited in claim 1 further comprising a plurality of network elements with at least one said network element connected in data communications with each said transmission unit.

9. A system as recited in claim 8 further comprising a local controller interconnecting said network controller with at least one said transmission unit and, alternatively, interconnecting one said network element with said at least one said transmission unit.

10. A method for creating a reconfigurable over-the-air optical data communications system which comprises the steps of:
mounting a plurality of transmission units at a respective plurality of separate locations to establish a mesh network having a plurality of line-of-sight optical communications links, wherein each said communication link interconnects one said transmission unit with another said transmission unit for communicating data therebetween;
connecting a network controller with each said communications link of said mesh network for monitoring a transmission quality factor for each said communications link; and
aiming at least one said transmission unit of a selected communications link to an alternate transmission unit to establish an alternate communication link in lieu of said selected communication link when said transmission quality factor of said selected communication link passes through a predetermined value to convert said mesh network into an alternate mesh network.

11. A method as recited in claim 10 further comprising the steps of:
providing a backbone network having a plurality of separate communications stations;
connecting each said communications station with at least one other said communications station; and
connecting at least one said transmission unit of each said communications link in data communications with at least one said communication station.

12. A method as recited in claim 11 wherein said step of connecting each said communications station with at least one other said communications station is accomplished using a land line.

13. A method as recited in claim 11 wherein said step of connecting each said communications station with at least one other said communications station is accomplished using an optical line-of-sight communications link.

14. A method as recited in claim 11 wherein each said communications station is connected with two other communications stations to form a closed communications loop for said backbone network.

15. A method as recited in claim 10 wherein said aiming step involves selectively aiming a light beam from said location in elevation and azimuth.

16. A method as recited in claim 15 wherein said network controller accomplishes the steps of:
determining said location of each said transmission unit in said mesh network; and
controlling elevation and azimuth of each said transmission unit to establish said line-of-sight optical communications links of said mesh network.

17. A method as recited in claim 10 further comprising the steps of:
connecting a plurality of network elements to said mesh network, with at least one said network element connected in data communications with each said transmission unit;
interconnecting said network controller with at least one said transmission unit; and
alternatively, interconnecting one said network element with said at least one said transmission unit.

18. A reconfigurable over-the-air optical data communications system which comprises:
a mesh network having a plurality of transmission units mounted at a respective plurality of separate locations, with each transmission unit being controllable to selectively establish one of a plurality of line-of-sight optical communications links for a determinable period of time, wherein each said communication link interconnects one said transmission unit with another said transmission unit for communicating data therebetween;
a backbone network having a plurality of separate communications stations wherein each said communications station is connected with at least one other said communications station; and
means for connecting at least one said transmission unit of each said communications link in data communications with at least one said communication station.

19. A system as recited in claim 18 further comprising a network controller electronically connected with each said communications link of said mesh network for monitoring a transmission quality factor for each said communications link, and for aiming at least one said transmission unit of a selected communications link to an alternate transmission unit to establish an alternate communication link in lieu of said selected communication link when said transmission quality factor of said selected communication link passes through a predetermined value to convert said mesh network into an alternate mesh network.

20. A system as recited in claim 19 wherein said network controller comprises:
means for determining said location of each said transmission unit in said mesh network; and
means connected with said aiming means of each said transmission unit for controlling elevation and azimuth of each said transmission unit to establish said line-of-sight optical communications links of said mesh network.
